(19) United States
(12) Patent Application Publication
(10) Pub. No.: US 2024/0373444 A1
(43) Pub. Date: Nov. 7, 2024

(54) METHOD AND APPARATUS FOR MANAGING SIDELINK RELAYING

(71) Applicant: Samsung Electronics Co., Ltd., Suwon-si, Gyeonggi-do (KR)

(72) Inventors: Milos TESANOVIC, Staines (GB); Anil AGIWAL, Suwon-si (KR); Hyunjeong KANG, Suwon-si (KR)

(21) Appl. No.: 18/683,764

(22) PCT Filed: Aug. 17, 2022
(86) PCT No.: PCT/KR2022/012257

§ 371 Date: Feb. 14, 2024

(30) Foreign Application Priority Data
Aug. 17, 2021 (GB) 2111764.3
Aug. 12, 2022 (GB) 2211791.5

(51) Int. Cl. H04W 72/25; H04L 47/11; H04W 76/27

(52) U.S. Cl. CPC H04W 72/25; H04L 47/115; H04W 76/27

(57) ABSTRACT

A method and an apparatus of a network node for managing sidelink relaying are provided. The method comprises identifying a first identifier, ID1, for a user equipment, UE, which is used in an adaptation layer, wherein the ID1 is mapped to a second identifier, ID2; and configuring the identified ID1 for the UE.

### TECHNICAL FIELD

The present invention relates to RRC connection management for Sidelink Relaying in a telecommunication system.

### BACKGROUND ART

Sidelink is a mechanism by which one User Equipment, UE, may communicate directly with another such UE, without relaying any messages via an external communication network. The external network or networks may be involved in setting up and facilitating such sidelink communication but the substantive communication between the UEs bypasses the network(s).

To extend and improve coverage of both in—and out-of-coverage UEs, Sidelink Relaying is being developed. A Relay UE may be a UE that provides functionality to support connectivity to the network for Remote UE(s). A Remote UE may be a UE that communicates with the network via a path including a Relay UE and/or which communicates with the network via a path including another Remote UE.

FIGS. 1 and 2 respectively show User and Control plane protocol stacks for L2 UE-to-NW Relay, as captured in the 3GPP document, TR 38.836v17.0.0.

FIGS. 1 and 2 show various interfaces and layers in a remote UE 10, a UE to Network Relay 20, a gNB 30 and the 5G Core 40.

Additionally, some details of Adapt on Uu are still under discussion but the main agreed functionality is mapping of Uplink, UL, PC5 bearers onto Uu bearers, while performing aggregation when needed, and performing the inverse process on the Downlink, DL.

At the RAN2 #113bis-e meeting, the following was agreed pertaining to L2 protocol architecture:
Proposal 3: For both DL and UL transmission of Uu radio bearers other than Signaling Radio Bearer 0, SRB0, identity information of a remote UE and its Uu radio bearer are included in the header of adaptation layer over Uu. For Further Study, FFS, for SRB0. FFS if the presence of adaptation layer header can be configurable. (24/24)
Proposal 3a: The radio bearer ID in the adaptation layer header is the Uu radio bearer ID of the remote UE. (23/24)
Proposal 3b: The UE ID in the adaptation layer header is a local, temporary remote UE ID. FFS whether the local, temporary remote UE ID is assigned by the relay UE, or the serving gNB of the relay UE. (23/24)
Proposal 3c: Mapping is done at Relay UE between PC5 RLC bearer IDs, identity information of remote UE and Uu radio bearer, and Uu RLC bearer IDs.

At the same meeting, the following agreements were additionally made:
Proposal 6-1: [20/23] [Easy] For the delivery of remote UE's SRB0 RRC message, specified (fixed) configuration is used for the configuration of PC5 RLC channel. FFS for the Uu RLC channel.
Proposal 6-2: [21/23, 22/23] [Easy] For the delivery of remote UE's SRB1 RRC message other than RRCResume and RRCReestablishment message, network configuration via dedicated signalling is used for the configuration of PC5 RLC channel and Uu RLC channel.
Proposal 6-3: [23/23] [Easy] For the delivery of remote UE's SRB1 RRC message such as RRCResume and RRCReestablishment message, default configuration is used for the configuration of PC5 RLC channel which can be reconfigured by network. FFS for Uu RLC channel.
Proposal 6-4: [21/23, 22/23] [Easy] For the delivery of remote UE's SRB2 RRC message, network configuration via dedicated signalling is used for the configuration of PC5 RLC channel and Uu RLC channel.
Proposal 6-5: [23/23, 23/23] [Easy] For the delivery of remote UE's Uu DRB packet, network configuration via dedicated signalling is used for the configuration of PC5 RLC channel and Uu RLC channel.

### DISCLOSURE OF INVENTION

### Solution to Problem

It is an aim of embodiments of the present invention to address the FFS items in Proposals 3, 3b, 6-1 and 6-3 in particular. In particular, embodiments of the invention aim to address:
The assignment of local/routing/Adapt remote UE ID for purposes of identification of UE for routing and bearer mapping in a Sidelink Relay network, and its mapping to other UE identifiers;
The mechanism of transmission of UL SRB0 from Remote UE to the gNB via the Relay UE, for the cases of Adapt being used for this purpose (on Uu), and Adapt not being used;
The configuration of Uu link for the transmission of SRB0;
The configuration of Uu link for the transmission of SRB1.

According to the present disclosure there is provided an apparatus and method as set forth in the appended claims. Other features of the disclosure will be apparent from the dependent claims, and the description which follows.

According to an embodiment of the present disclosure, a method for managing sidelink relaying by a network node is provided. The method may comprise identifying a first identifier, ID1, for a user equipment, UE, which is used in an adaptation layer. The ID1 is mapped to a second identifier, ID2. The method may comprise configuring the identified ID1 for the UE.

In an embodiment, the network node is one of a base station, gNB, and a relay UE.

In an embodiment, the ID1 is at least one of a local identifier, a temporary identifier, a relaying identifier, a routing identifier and an adaptation layer identifier.

In an embodiment, the ID1 is carried in a packet in the adaptation layer.

In an embodiment, the ID1 is carried is in a packet header of the packet.

In an embodiment, the ID2 is one of an identifier relating to a different layer, an identifier relating to a higher layer, and a source layer-2, SRC L2, ID.

In an embodiment, the UE is a remote UE.

In an embodiment, the configuration is performed by an RRCReconfiguration message.

In an embodiment, the configuration is performed by an RRCReconfiguration message sent to a relay UE from a base station.

In an embodiment, for Signalling Radio Bearer 0, SRB0, of the UE, an uplink Uu transmission is carried on the adaptation layer.

According to an embodiment of the present disclosure, an apparatus of a network node for managing sidelink relaying is provided. The network node comprises a transceiver, and at least one processor coupled to the transceiver. The at least one processor may be configured to identify a first identifier, ID1, for a user equipment, UE, which is used in an adaptation layer. The ID1 is mapped to a second identifier, ID2. The at least one processor may be configured to configure the identified ID1 for the UE.

According to an embodiment of the present disclosure, a non-transitory computer readable medium storing instructions for managing sidelink relaying is provided. The instructions, when executed by at least one processor of an apparatus, cause the apparatus to perform operations. The operations may comprise identifying a first identifier, ID1, for a user equipment, UE, which is used in an adaptation layer. The ID1 is mapped to a second identifier, ID2. The operations may comprise configuring the identified ID1 for the UE.

Although a few preferred embodiments of the present disclosure have been shown and described, it will be appreciated by those skilled in the art that various changes and modifications might be made without departing from the scope of the disclosure, as defined in the appended claims.

### BRIEF DESCRIPTION OF DRAWINGS

For a better understanding of the disclosure, and to show how embodiments of the same may be carried into effect, reference will now be made, by way of example only, to the accompanying diagrammatic drawings in which:

FIG. 1 shows a User Plane Protocol stack in connection with a sidelink setup, known in the related art;

FIG. 2 shows a Control Plane Protocol stack in connection with a sidelink setup, known in the related art;

FIG. 3 shows a flowchart for a method according to an embodiment of the disclosure.

FIG. 4 shows a block diagram of an apparatus according to an embodiment of the disclosure.

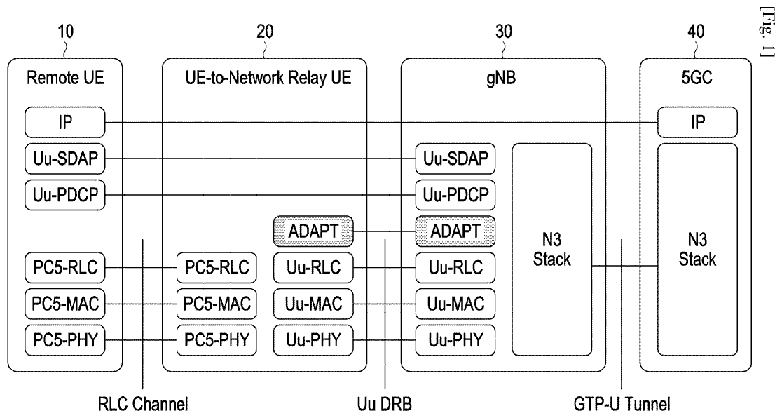

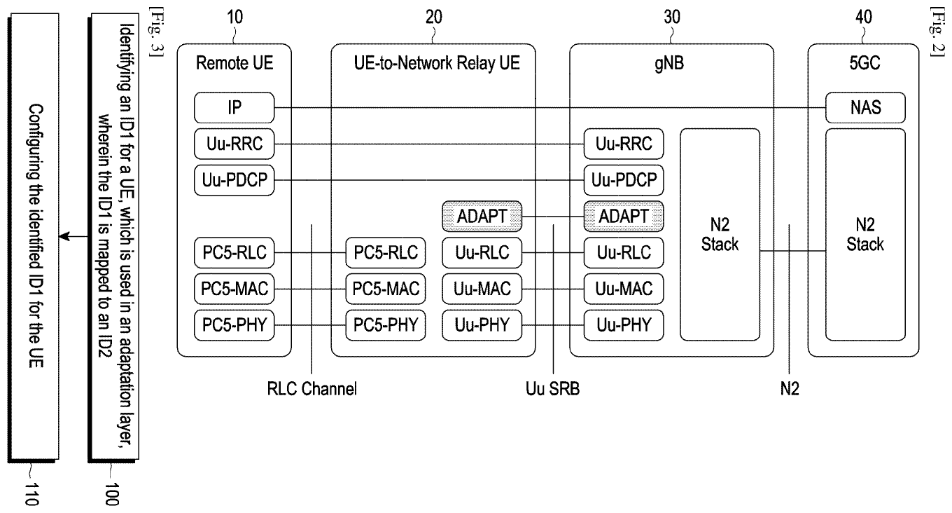

### MODE FOR THE INVENTION

Based on the current status in 3GPP, the Uu Adapt layer may or may not be used for transmission of SRB0 message from Remote UE 10 to the gNB 30. Embodiments of the present disclosure address both of these scenarios.

In an embodiment of this disclosure, it is assumed that UL SRB0 is transmitted using Adapt layer i.e. UL SRB0 from Remote UE 10 is wrapped in an Adapt packet and uses an Adapt header, which may carry some kind of identifier of the Remote UE 10.

An embodiment comprises four options. These options may exist independent of each other or may be combined in any suitable manner.

Option 1: there is no Adapt-specific ID in the header for UL SRB0. In this case, a procedure is provided whereby the Relay UE 20 uses the knowledge of Remote UE's S-TMSI, provided by the Remote UE 10 to the Relay UE 20 for paging purposes. The gNB 30 then creates/configures a local ID which is mapped to the Remote UE's S-TMSI. This configuration is sent to the Relay UE 20 via the Relay UE's RRCReconfiguration message. This local ID, carried in the Adapt header, is then used for routing (for the Relay UE 20 to send the DL response to the appropriate Remote UE 10). Throughout the following the Local ID may alternatively be one of a temporary identifier, a relaying identifier, a routing identifier and an adaptation layer identifier.

In a variation of this option, for the case of Remote UE 10 in RRC_INACTIVE state, short/full I-RNTI (already provided by the gNB to the Remote UE within an RRC Release message when the Remote UE 10 moved from RRC Connected to RRC Inactive) is provided to the Relay UE 20 for paging purposes, the same as S-TMSI above.

In a further variation of this option, the local ID assigned by the gNB 30 may need to be changed for purposes of data relaying later on. This can happen in any of the following cases, each being part of the embodiment:
serving gNB changes;
serving gNB allocates another local ID (e.g. in case the same local ID is assigned/ends up being assigned to multiple Remote UEs);
Relay UE (and not the gNB like in cases above) is the entity that allocates/modifies the ‘permanent’ local ID and then informs the gNB (in this case the new ‘permanent’ local ID needs to be sent to the gNB).

Option 2: source layer-2 identifier, SRC L2 ID, of Remote UE 10 (24 bits in length) is used in the header for both directions (UL and DL). The SRC L2 ID of Remote UE 10 is provided to Relay UE 20 during PC5 link establishment between Remote UE 10 and Relay UE 20. It is assumed that Relay UE 20 sends SRC L2 ID in Adapt header to gNB 30. gNB 30 also sends the same SRC L2 ID in Adapt header to Relay UE 20. In this case, the gNB 30 does not have to send Adapt (local ID)-to-S-TMSI/I-RNTI mapping to the Relay UE 20.

Option 3: SRC L2 ID of Remote UE 10 (24 bits) is sent in the Adapt header for UL SRB0. The gNB 30 then configures local ID which is mapped to Remote UE's SRC L2 ID or S-TMSI (as both IDs are present in the UL message-SRC L2 ID in the Adapt header, and S-TMSI as part of Remote UE's SRB0 signalling (e.g. RRCSetupRequest message). The configuration (mapping) is sent to Relay UE 20 via Relay UE's RRCReconfiguration message. The local ID is carried in the adapt header.

The local ID can be mapped to either Remote UE's SRC L2 ID or Remote UE's S-TMSI (Remote UE's short/full I-RNTI in RRC_INACTIVE). SRC L2 ID is carried in UL Adapt header and S-TMSI is carried inside the Remote UE's SRB0 signalling (e.g., RRCSetupRequest). It is assumed that the Relay UE 20 already knows both SRC L2 ID and S-TMSI (or short/full I-RNTI in case of RRC_INACTIVE Remote UE). In more general terms the SRC L2 ID may be referred to as a second ID, a different ID, a higher layer ID, or an ID pertaining to a different layer. These terms may be used interchangcably.

The gNB 30 sends Adapt ID-to-SRC L2 ID (or S-TMSI or short/full I-RNTI) mapping in RRC message to the Relay UE 20, and the gNB 30 then sends the response message for Remote UE 10 to Relay UE 20 with this local ID carried in the Adapt header so that the Relay UE 20 may route the response message to the Remote UE 10.

In option 3, much like in option 1, it is assumed that a separate local ID configuration procedure occurs between the gNB 30 and the Relay UE 20 before sending a DL response to the Remote UE's SRB0.

Option 4: SL SRC L2 ID of the Remote UE 10 is sent in a MAC CE of a MAC PDU which includes the SRB0 message of the Remote UE 10. If the MAC PDU includes multiple SRB0 messages from different Remote UEs 10, Multiple SL SRC L2 IDs corresponding to the Remote UEs 10 can be included in the MAC PDU in the same order in which the MAC SDUs of Remote UEs 10 are included in the MAC PDU for transmission on the Uu link.

The bit size of the local ID can be smaller than 24 bits (which is the size of SRC L2 ID of the Remote UE 10) and the header size can be different for UL SRB0 and other messages when SRC L2 ID is carried in Adapt header of UL SRB0. Two sizes of adapt header are described herein.

In another embodiment, one size of adapt header is used whereby local ID is carried in Adapt header and the bit size of the local ID is smaller than 24 bits, and SRC L2 ID for fSRB0UL SRB0 can be carried as e.g. subheader of adapt header or control signalling of adapt header, instead of carried in Adapt header.

In all of the above cases, apart from Option 2, the Adapt header for SRB0 transmission is different from a ‘regular’ Adapt header. The size of the Adapt header for SRB0 may be made variable e.g. based on target signalling load (i.e. use a shorter ID option when needed/configured). In option 2, above, however, SRC L2 ID is used in the Adapt header as Remote UE 10 ID so, in this case, the SRC L2 ID is used in the adapt header for the transmission/reception of any of Remote UE's SRBs/DRBs, and not just SRB0.

Embodiments of this disclosure also relate to the Uu configuration for the Remote UE's SRB0 transmission. This refers o the configuration of one or more specific radio bearer(s) to carry Remote UE's SRB0. In one embodiment, the configuration is fixed in the specification. In this case, the same configuration (e.g. same SRB or same DRB) is applied for any Remote UE's SRB0 relayed by the Relay UE 20 in question.

In a refinement of this embodiment, the configuration is fixed in specification and also sent in an RRC message (or System Information, SI). If the Relay UE 20 does not receive the configuration in the RRC message (or SI) from the gNB 30, it then applies the fixed configuration.

Note that the difference between a fixed configuration and dedicated signalling is in the way that the parameter value is configured and possibly modified. For the former, the parameter value is in the specification and, for the latter, the parameter values can be configured or modified by the network.

An embodiment of the disclosure also relates to the timing of the establishment by the Relay UE 20 of this Uu DRB or Uu SRB for carrying Remote UE's SRB0. One option is that Relay UE 20 establishes this UU DRB or UU SRB once the very first Remote UE's SRB0 message is received. Alternatively, the Relay UE 20 can always keep it established.

If dedicated signalling is used by the gNB 30 (as mentioned above, instead of or in addition to a fixed configuration), both these options are also available. For the former case (the Relay UE 20 establishes this UU DRB or UU SRB once the very first Remote UEs SRB0 message is received), the Relay UE 20 can further request that the gNB 30 should make the configuration after the Relay UE 20 receives SRB0 signalling over PC5. For the latter case (the Relay UE can always keep it established), the gNB 30 can send the configuration to the Relay UE 20 once the Relay UE 20 announces itself as the Relay UE 20.

In the case where UL SRB0 is sent by the Remote UE 10 after the connection is established with the Relay UE 20 but before the gNB 30 has configured the Uu configuration, the Relay UE 20 will either wait for configuration, or apply the fixed configuration, or apply the configuration from SI (if available), or apply the configuration from pre-configuration.

For the case of Adapt header not being used for UL transmission of Remote UE's SRB0, an embodiment permits the creation of several SRB0 configurations (fixed), for a possibly limited number of Remote UEs 10. In other words, a separate Uu DRB or Uu SRB is configured for transmission of each individual Remote UE's SRB0. In this case, SRB0 configurations are not shared among Remote UEs 10, and each Remote UE's SRB0 is relayed with one specific SRB0 configuration among the several SRB0 configurations. The gNB 30 and Relay UE 20 can thus identify which DL SRB0/SRB1 (response to UL SRB0) is for which Remote UE 10. The list of Uu DRBs or Uu SRBs for SRB0 can be configured by the gNB 30 when the Relay UE 20 enters RRC Connected and indicates its interest in relaying.

For the transmission of Remote UE's SRB1 (e.g. RRCResume and RRCReestablishment messages), a default configuration is used, which is configured by the network's dedicated signalling and can be reconfigured by the network's dedicated signalling.

FIG. 3 shows a flowchart illustrating an embodiment of the present disclosure. At step 100, a network node identifies a first identifier, ID1, for a User Equipment, UE, which is used in an adaptation layer. The ID1 is mapped to a second identifier, ID2. At step 110, the network node configures the identified ID1 for the UE.

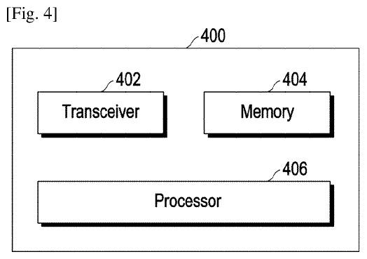

FIG. 4 illustrates shows a block diagram of an apparatus according to an embodiment of the disclosure. The apparatus (400) may be an apparatus of a network node. The network node may be one of a base station, a gNB, a UE including a relaying UE or a remote UE.

The apparatus (400) may comprise a transceiver (402), a memory (404), and a processor (406).

The processor (406) may be a single processor, may refer to a set of a plurality of processors. The processor (406) may include various processing circuitry and communicates with, the memory (404) and the transceiver (402). The processor (406) is configured to execute instructions stored in the memory (404) for managing sidelink relaying. The processor (406) may include one or a plurality of processors, may be a general purpose processor, such as a central processing unit (CPU), an application processor (AP), or the like, a graphics-only processing unit such as a graphics processing unit (GPU), a visual processing unit (VPU), and/or an Artificial intelligence (AI) dedicated processor such as a neural processing unit (NPU). The processor (406) may be referred to as at least one processor. The processor (406) may be referred to as a controller.

The processor (1206) may be configured to directly or indirectly execute operations of the network node described above including the operations in FIG. 3.

Storage elements of the memory (404) storage elements may include magnetic hard discs, optical discs, floppy discs, flash memories, or forms of electrically programmable memories (EPROM) or electrically erasable and programmable (EEPROM) memories. In addition, the memory (404) may, in some examples, be considered a non-transitory storage medium. The term “non-transitory” may indicate that the storage medium is not embodied in a carrier wave or a propagated signal. However, the term “non-transitory” should not be interpreted that the memory (404) is non-movable. The non-transitory storage medium may store data that can, over time, change (e.g., in Random Access Memory (RAM) or cache). The memory (404) may be an internal storage. In some embodiments, at least a part of the memory (404) may be an external storage unit of the apparatus (400), cloud storage, or any other type of external storage.

The memory (404) may store instructions to be executed by the processor (406) for the apparatus (400) performing corresponding operations.

The apparatus (400) or the processor (406) may communicate with other entities through the transceiver (402). The transceiver (402) may include various communication circuitry for communicating with external device via one or networks. The transceiver (402) may include an electronic circuit specific to a standard that enables wired or wireless communication.

At least some of the example embodiments described herein may be constructed, partially or wholly, using dedicated special-purpose hardware. Terms such as ‘component’, ‘module’ or ‘unit’ used herein may include, but are not limited to, a hardware device, such as circuitry in the form of discrete or integrated components, a Field Programmable Gate Array (FPGA) or Application Specific Integrated Circuit (ASIC), which performs certain tasks or provides the associated functionality. In some embodiments, the described elements may be configured to reside on a tangible, persistent, addressable storage medium and may be configured to execute on one or more processors. These functional elements may in some embodiments include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. Although the example embodiments have been described with reference to the components, modules and units discussed herein, such functional elements may be combined into fewer elements or separated into additional elements. Various combinations of optional features have been described herein, and it will be appreciated that described features may be combined in any suitable combination. In particular, the features of any one example embodiment may be combined with features of any other embodiment, as appropriate, except where such combinations are mutually exclusive. Throughout this specification, the term “comprising” or “comprises” means including the component(s) specified but not to the exclusion of the presence of others.

Attention is directed to all papers and documents which are filed concurrently with or previous to this specification in connection with this application and which are open to public inspection with this specification, and the contents of all such papers and documents are incorporated herein by reference.

All of the features disclosed in this specification (including any accompanying claims, abstract and drawings), and/or all of the steps of any method or process so disclosed, may be combined in any combination, except combinations where at least some of such features and/or steps are mutually exclusive.

Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features.

The disclosure is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

1-12. (canceled)

13. A method for communication by a relay user equipment (UE) using an adaptation protocol for a sidelink relay in a wireless communication system, the method comprising:
receiving, from a base station, a radio resource control (RRC) message for configuration associated with the relay UE, wherein the RRC message includes a local ID of a remote UE used for the adaptation protocol for the sidelink relay; and
performing a sidelink relay operation based on the local ID of the remote UE.

14. The method of claim 13, wherein the RRC message is an RRC reconfiguration message for configuration of the relay UE.

15. The method of claim 13, further comprising receiving a packet from the remote UE;
including identity information of the remote UE in the packet, wherein the identity information of the remote UE corresponds to the local ID of the remote UE; and
transmitting the packet including the identity information of the remote UE.

16. The method of claim 15, wherein including the identity information of the remote UE in the packet comprises if the received packet is not associated with a signaling radio bearer 0 (SRB0), including the identity information of the remote UE in the packet.

17. The method of claim 15, wherein the identity information of the remote UE is in a header for the adaptation protocol for the sidelink relay.

18. The method of claim 15, wherein the identity information of the remote UE is associated with a bearer information related to a Uu radio link control RLC channel for the remote UE.

19. A relay user equipment (UE) using an adaptation protocol for a sidelink relay in a wireless communication system, the relay UE comprising:
a transceiver; and
at least one processor coupled to the transceiver, wherein the processor is configured to:
receive, from a base station, a radio resource control (RRC) message for configuration associated with the relay UE, wherein the RRC message includes a local ID of a remote UE used for the adaptation protocol for the sidelink relay; and
perform a sidelink relay operation based on the local ID of the remote UE.

20. The relay UE of claim 19, wherein the RRC message is an RRC reconfiguration message for configuration of the relay UE.

21. The relay UE of claim 19, wherein the at least one processor is further configured to:
receive a packet from the remote UE;
include identity information of the remote UE in the packet, wherein the identity information of the remote UE corresponds to the local ID of the remote UE; and
transmit the packet including the identity information of the remote UE.

22. The relay UE of claim 21, wherein the at least one processor is configured to if the received packet is not associated with a signaling radio bearer 0 (SRB0), include the identity information of the remote UE in the packet.

23. The relay UE of claim 21, wherein the identity information of the remote UE is in a header for the adaptation protocol for the sidelink relay.

24. The relay UE of claim 21, wherein the identity information of the remote UE is associated with a bearer information related to a Uu radio link control RLC channel for the remote UE.
